(19) United States
(12) Patent Application Publication
(10) Pub. No.: US 2024/0318913 A1
(43) Pub. Date: Sep. 26, 2024

(54) HEAT TREATMENT FURNACE AND SLIDING UNIT

(71) Applicants: NGK INSULATORS, LTD., Nagoya-Shi (JP); NGK KILNTECH, CORPORATION, Nagoya-Shi (JP); NGK ADREC CO., LTD., Kani-Gun (JP)

(72) Inventors: Minoru YAMAGUCHI, Nagoya-Shi (JP); Tsuneo KOMIYAMA, Kani-Gun (JP); Takeshi KOMAKI, Nagoya-Shi (JP); Terukazu IWATA, Nagoya-Shi (JP); Kazuya NARUMIYA, Nagoya-Shi (JP)

(73) Assignees: NGK INSULATORS, LTD., Nagoya-Shi (JP); NGK KILNTECH, CORPORATION, Nagoya-Shi (JP); NGK ADREC CO., LTD., Kani-Gun (JP)

(21) Appl. No.: 18/610,435

(22) Filed: Mar. 20, 2024

(30) Foreign Application Priority Data
Mar. 22, 2023 (JP) 2023-045190
Jan. 11, 2024 (JP) 2024-002402

(51) Int. Cl. F27B 9/22; F27B 9/26; F27B 9/30

(52) U.S. Cl. CPC F27B 9/22; F27B 9/26; F27B 2009/305

(57) ABSTRACT

A heat treatment furnace may include: a furnace body including an entrance and an exit; a lower plate member disposed in the furnace body; an upper plate member disposed above the lower plate member, wherein the upper plate member is configured to allow the plurality of objects stacked in an up-down direction to be placed thereon; an intermediate member interposed between the lower plate member and the upper plate member in the up-down direction and attached to the lower plate member; and a pusher configured to push the upper plate member forward from the entrance toward the exit. The upper plate member may move forward above the lower plate member. A sliding resistance between the upper plate member and the intermediate member may be smaller than a sliding resistance between the upper plate member and the lower plate member.

### REFERENCE TO RELATED APPLICATIONS

This application claims priority to Japanese Patent Application No. 2023-45190, filed on Mar. 22, 2023 and Japanese Patent Application No. 2024-2402, filed on Jan. 11, 2024, the entire contents of which are hereby incorporated by reference into the present application.

### TECHNICAL FIELD

The disclosure herein relates to heat treatment furnaces and sliding units.

### BACKGROUND ART

Japanese Patent Application Publication No. 2020-535371 describes a heat treatment furnace that heat-treats objects. In this heat treatment furnace, a plurality of objects stacked in an up-down direction is placed on an upper plate member. The upper plate member, with the plurality of objects placed thereon, is pushed by a pusher, so that it moves forward within the furnace body from its entrance toward the exit. While moving within the furnace body, the upper plate member moves above a lower plate member.

### SUMMARY

In heat treatment furnaces such as the one described in Japanese Patent Application Publication No. 2020-535371, it is desirable that an upper plate member can easily move above a lower plate member.

The disclosure herein provides technology for allowing an upper plate member to easily move above a lower plate member.

In a first aspect of the technology disclosed herein, a heat treatment furnace may be configured to heat-treat a plurality of objects. The heat treatment furnace may comprise a furnace body comprising an entrance and an exit; a lower plate member disposed in the furnace body; an upper plate member disposed above the lower plate member, wherein the upper plate member is configured to allow the plurality of objects stacked in an up-down direction to be placed thereon; an intermediate member interposed between the lower plate member and the upper plate member in the up-down direction and attached to the lower plate member; and a pusher configured to push the upper plate member forward from the entrance toward the exit. The upper plate member may move forward above the lower plate member. A sliding resistance between the upper plate member and the intermediate member may be smaller than a sliding resistance between the upper plate member and the lower plate member.

According to the configuration above, the sliding resistance between the upper plate member and the intermediate member is smaller than the sliding resistance between the upper plate member and the lower plate member. Therefore, the configuration above allows the upper plate member to move easily above the lower plate member, as compared to a configuration in which the heat treatment furnace does not comprise the intermediate member.

In an eighteenth aspect of the disclosure herein, a heat treatment furnace may be configured to heat-treat a plurality of objects. The heat treatment furnace may comprise a furnace body comprising an entrance and an exit; a lower plate member disposed in the furnace body; an upper plate member disposed above the lower plate member, wherein the upper plate member is configured to allow the plurality of objects stacked in an up-down direction to be placed thereon; an intermediate member interposed between the lower plate member and the upper plate member in the up-down direction and attached to the upper plate member; and a pusher configured to push the upper plate member forward from the entrance toward the exit. The upper plate member may move forward above the lower plate member. A sliding resistance between the lower plate member and the intermediate member may be smaller than a sliding resistance between the lower plate member and the upper plate member.

According to the configuration above, the sliding resistance between the lower plate member and the intermediate member is smaller than the sliding resistance between the upper plate member and the lower plate member. Therefore, the configuration above allows the upper plate member to move easily above the lower plate member, as compared to a configuration in which the heat treatment furnace does not comprise the intermediate member.

In a thirty-sixth aspect of the disclosure herein, a sliding unit may be used under a high temperature condition. The sliding unit may comprise a lower plate member; an upper plate member disposed above the lower plate member; and an intermediate member interposed between the lower plate member and the upper plate member in an up-down direction and attached to the lower plate member. The upper plate member may be configured to move forward above the lower plate member. A sliding resistance between the upper plate member and the intermediate member may be smaller than a sliding resistance between the upper plate member and the lower plate member.

According to the configuration above, the sliding resistance between the upper plate member and the intermediate member is smaller than the sliding resistance between the upper plate member and the lower plate member. Therefore, the configuration above allows the upper plate member to move easily above the lower plate member, as compared to a configuration in which the sliding unit does not comprise the intermediate member.

In a thirty-seventh aspect of the disclosure herein, a sliding unit may be used under a high temperature condition. The sliding unit may comprise a lower plate member; an upper plate member disposed above the lower plate member; and an intermediate member interposed between the lower plate member and the upper plate member in an up-down direction and attached to the upper plate member. The upper plate member may be configured to move forward above the lower plate member. A sliding resistance between the lower plate member and the intermediate member may be smaller than a sliding resistance between the lower plate member and the upper plate member.

According to the configuration above, the sliding resistance between the lower plate member and the intermediate member is smaller than the sliding resistance between the upper plate member and the lower plate member. Therefore, the configuration above allows the upper plate member to move easily above the lower plate member, as compared to the configuration in which the sliding unit does not comprise the intermediate member.

### BRIEF DESCRIPTION OF DRAWINGS

FIG. 1 is a schematic cross-sectional view of a heat treatment furnace according to a first embodiment.

FIG. 2 is a schematic cross-sectional view along a line II-II in FIG. 1.

FIG. 3 is a side view of objects to be treated and a sliding unit according to the first embodiment.

FIG. 4 is a cross-sectional view of the sliding unit according to the first embodiment.

FIG. 5 is a top view of the sliding unit according to the first embodiment.

FIG. 6 is a top view of a sliding unit according to a variant of the first embodiment.

FIG. 7 is an enlarged cross-sectional view of the sliding unit according to the first embodiment.

FIG. 8 is a cross-sectional view of a sliding unit according to a variant of the first embodiment.

FIG. 9 is a cross-sectional view of a lower plate member and an intermediate member according to a variant of the first embodiment.

FIG. 10 is a cross-sectional view of a lower plate member and an intermediate member according to a variant of the first embodiment.

FIG. 11 is a top view of a sliding unit according to a variant of the first embodiment.

FIG. 12 is a cross-sectional view of a sliding unit according to a second embodiment.

FIG. 13 is a bottom view of an upper plate member and an intermediate member according to the second embodiment.

FIG. 14 is an enlarged cross-sectional view of the sliding unit according to the second embodiment.

FIG. 15 is a top view of a sliding unit according to a third embodiment.

FIG. 16 is a top view of a sliding unit according to a variant of the third embodiment.

FIG. 17 is a bottom view of an upper plate member and an intermediate member according to a fourth embodiment.

FIG. 18 is a bottom view of an upper plate member and an intermediate member according to a variant of the fourth embodiment.

FIG. 19 is a top view of a sliding unit according to a fifth embodiment.

FIG. 20 is a top view of a sliding unit according to a variant of the fifth embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment furnaces and sliding units, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the technology disclosed herein according to the first aspect, a coefficient of dynamic friction of the intermediate member to the upper plate member may be equal to or less than 0.5. This configuration allows the upper plate member to more easily move above the lower plate member.

In a third aspect of the technology disclosed herein according to the first or second aspect above, the lower plate member may comprise a first facing surface facing the upper plate member; and a recess recessed from the first facing surface. The intermediate member may comprise a received portion received in the recess; and a protruding portion protruding beyond the first facing surface toward the upper plate member. This allows the upper plate member to easily move above the lower plate member via a simple configuration.

In a fourth aspect of the technology disclosed herein according to the third aspect above, the protruding portion may comprise a chamfer at a corner of a rear end of the protruding portion. In this configuration, the upper plate member moves above the lower plate member from the rear end of the protruding portion toward the front end thereof. Since the chamfer is located at the rear end of the protruding portion, the upper plate member is prevented from getting caught on the rear end of the protruding portion. Therefore, the upper plate member can easily move above the lower plate member.

In a fifth aspect of the technology disclosed herein according to the fourth aspect above, a length of the chamfer in a front-rear direction may be equal to or more than three times a length of the chamfer in the up-down direction and equal to or less than 20 times the length of the chamfer in the up-down direction. This configuration suppresses the upper plate member from getting caught on the rear end of the protruding portion. Therefore, the upper plate member can more easily move above the lower plate member.

In a sixth aspect of the technology disclosed herein according to any one of the third to fifth aspects above, a length of the received portion in the front-rear direction may be less than a length of the recess in the front-rear direction. If the length of the received portion in the front-rear direction is equal to the length of the recess in the front-rear direction and a thermal expansion coefficient of the intermediate member is greater than that of the lower plate member, the lower plate member cannot expand in the front-rear direction to the comparable extent to the intermediate member when heated. This may generate thermal stress between the received portion of the intermediate member and the recess of the lower plate member, leading to damage to the intermediate member and the lower plate member. According to the configuration above, even when the lower plate member cannot expand to the comparable extent to the intermediate member, thermal stress between the intermediate member and the lower plate member can be reduced. Therefore, damage to the intermediate member and the lower plate member can be suppressed.

In a seventh aspect of the technology disclosed herein according to the sixth aspect above, a length obtained by subtracting the length of the received portion in the front-rear direction from the length of the recess in the front-rear direction may be equal to or less than 2% of the length of the recess in the front-rear direction. If the length obtained by subtracting the length of the received portion in the front-rear direction from the length of the recess in the front-rear direction is more than 2% of the length of the recess in the front-rear direction, this can suppress damage to the intermediate member caused by the thermal expansion of the intermediate member. However, the relatively large clearance in the recess amounts to a relatively short length of the intermediate member in the front-rear direction. Since the area of the intermediate member that is subjected to a load is reduced, the intermediate member becomes more susceptible to wear. The configuration above can suppress damage to the intermediate member caused by the thermal expansion of the intermediate member and also can reduce wear of the intermediate member as compared to the configuration in which the length obtained by subtracting the length of the received portion in the front-rear direction from the length of the recess in the front-rear direction is more than 2% of the length of the recess in the front-rear direction.

In an eighth aspect of the technology disclosed herein according to any one of the third to seventh aspects, the protruding portion may comprise a second facing surface facing the upper plate member. An arithmetic average roughness of the second facing surface may be equal to or less than 10 micrometers. This configuration allows for a further reduction in the sliding resistance between the upper plate member and the intermediate member. Therefore, the upper plate member can move more easily above the lower plate member.

In a ninth aspect of the technology disclosed herein according to any one of the first to eighth aspects above, a porosity of the intermediate member may be equal to or less than 1%. The porosity of the intermediate member being equal to or less than 1% means that there is less pore formation at a surface of the intermediate member. Thus, the surface of the intermediate member is smooth. This allows for a further reduction in the sliding resistance between the upper plate member and the intermediate member.

In a tenth aspect of the technology disclosed herein according to the nineth aspect above, the porosity of the intermediate member may be less than both of a porosity of the upper plate member and a porosity of the lower plate member. This configuration allows for a further reduction in the sliding resistance between the upper plate member and the intermediate member and thus suppresses wear of the intermediate member.

In an eleventh aspect of the technology disclosed herein according to the tenth aspect above, a bending strength of the intermediate member may be equal to or more than 150 MPa and equal to or less than 400 MPa. This configuration suppresses damage to the intermediate member caused by the weight of the upper plate member.

In a twelfth aspect of the technology disclosed herein according to any one of the first to eleventh aspects, the intermediate member may comprise a plurality of intermediate members interposed between the lower plate member and the upper plate member in the up-down direction. The plurality of intermediate members is aligned along the front-rear direction. This configuration allows for a reduction in bending stress on the intermediate members, as compared to a configuration using a single elongated intermediate member.

In a thirteenth aspect of the technology disclosed herein according to any one of the first to twelfth aspects, the intermediate member may be constituted of ceramics including a transition metal or a poor metal. In this configuration, the intermediate member is more resistant to heat than an intermediate member constituted of a material other than the ceramics. Therefore, thermal damage to the intermediate member can be suppressed in the heat treatment furnace for use under a high temperature condition.

In a fourteenth aspect of the technology disclosed herein according to the thirteenth aspect above, the ceramics may comprise non-oxide ceramics including the transition metal. This configuration suppresses thermal damage to the intermediate member while allowing the upper plate member to easily move above the lower plate member.

In a fifteenth aspect of the technology disclosed herein according to the fourteenth aspect, the non-oxide ceramics may be TiB2, TiCN, or MoSi2. This configuration allows the intermediate member to have increased hardness while suppressing thermal damage to the intermediate member. The configuration also allows the intermediate member to have a reduced friction coefficient and allows the upper plate member to move more easily above the lower plate member.

In a sixteenth aspect of the technology disclosed herein according to the thirteenth aspect above, the ceramics may comprise oxide ceramics including the transition metal or the poor metal. This configuration allows the intermediate member to have increased hardness while suppressing thermal damage to the intermediate member. The configuration also allows the intermediate member to have a reduced friction coefficient and allows the upper plate member to move easily above the lower plate member.

In a seventeenth aspect of the technology disclosed herein according to the sixteenth aspect above, the oxide ceramics may be Cr2O3, Al2O3, or Al6O13Si2. This configuration allows the intermediate member to have increased hardness, while suppressing thermal damage to the intermediate member. The configuration also allows for a reduction in the sliding resistance between the upper plate member and the intermediate member and allows the upper plate member to move easily above the lower plate member.

In a nineteenth aspect of the technology disclosed herein according to the eighteenth aspect above, a coefficient of dynamic friction of the intermediate member to the lower plate member may be equal to or less than 0.5. This configuration allows the upper plate member to easily move above the lower plate member.

In a twentieth aspect of the technology disclosed herein according to the eighteenth or nineteenth aspect, the upper plate member may comprise a first facing surface facing the lower plate member; and a recess recessed from the first facing surface. The intermediate member may comprise a received portion received in the recess; and a protruding portion protruding beyond the first facing surface toward the lower plate member. This allows the upper plate member to easily move above the lower plate member via a simple configuration.

In a twenty-first aspect of the technology disclosed herein according to the twentieth aspect above, the protruding portion may comprise a chamfer at a corner of a front end of the protruding portion. In this configuration, the upper plate member moves above the lower plate member such that the lower plate member moves from the front end of the protruding portion toward the rear end thereof. Since the chamfer is located at the front end of the protruding portion, the lower plate member is prevented from getting caught on the front end of the protruding portion. Therefore, the upper plate member can easily move above the lower plate member.

In a twenty-second aspect of the technology disclosed herein according to the twenty-first aspect above, a length of the chamfer in the front-rear direction may be equal to or more than three times a length of the chamfer in the up-down direction and equal to or less than 20 times the length of the chamfer in the up-down direction. This configuration suppresses the lower plate member from getting caught on the front end of the protruding portion. Therefore, the upper plate member can more easily move above the lower plate member.

In a twenty-third aspect of the technology disclosed herein according to any one of the twentieth to twenty-second aspects, a length of the received portion in the front-rear direction may be less than a length of the recess in the front-rear direction. If the length of the received portion in the front-rear direction is equal to the length of the recess in the front-rear direction and a thermal expansion coefficient of the intermediate member is greater than that of the upper plate member, the upper plate member cannot expand in the front-rear direction to the comparable extent relative to the intermediate member when the intermediate member expands. This may generate thermal stress between the received portion of the intermediate member and the recess of the upper plate member, leading to damage to the intermediate member and the upper plate member. According to the configuration above, even when the upper plate member cannot expand to the comparable extent relative to the intermediate member, thermal stress between the intermediate member and the upper plate member can be reduced. Therefore, damage to the intermediate member and the upper plate member can be suppressed.

In a twenty-fourth aspect of the technology disclosed herein according to the twenty-third aspect, a length obtained by subtracting the length of the received portion in the front-rear direction from the length of the recess in the front-rear direction may be equal to or less than 2% of the length of the recess in the front-rear direction. If the length obtained by subtracting the length of the received portion in the front-rear direction from the length of the recess in the front-rear direction is greater than 2% of the length of the recess in the front-rear direction, this suppresses damage to the intermediate member caused by the thermal expansion of the intermediate member. However, the relatively large clearance in the recess amounts to a relatively short length of the intermediate member in the front-rear direction. Since the area of the intermediate member that is subjected to a load is reduced, the intermediate member becomes more susceptible to wear. The configuration above can suppress damage to the intermediate member caused by its thermal expansion and also can reduce wear of the intermediate member as compared to a configuration in which the length obtained by subtracting the length of the received portion in the front-rear direction from the length of the recess in the front-rear direction is greater than 2% of the length of the recess in the front-rear direction.

In a twenty-fifth aspect of the technology disclosed herein according to any one of the twentieth to twenty-fourth aspects, the protruding portion may comprise a second facing surface facing the lower plate member. An arithmetic average roughness of the second facing surface may be equal to or less than 10 micrometers. This configuration allows for a further reduction in the sliding resistance between the lower plate member and the intermediate member. Therefore, the upper plate member can move more easily above the lower plate member.

In a twenty-sixth aspect of the technology disclosed herein according to any one of the eighteenth to twenty-fifth aspects above, the intermediate member may be attached to the upper plate member via an adhesive. This allows the intermediate member to be attached to the upper plate member via a simple configuration.

In a twenty-seventh aspect of the technology disclosed herein according to any one of the eighteenth to twenty-sixth aspects, a porosity of the intermediate member may be equal to or less than 1%. This configuration has the same effect as that of the configuration according to the ninth aspect.

In a twenty-eighth aspect of the technology disclosed herein according to the twenty-seventh aspect above, the porosity of the intermediate member may be less than both of a porosity of the upper plate member and a porosity of the lower plate member. This configuration allows for a further reduction in the sliding resistance between the lower plate member and the intermediate member and thus suppresses wear of the intermediate member.

In a twenty-nineth aspect of the technology disclosed herein according to the twenty-eighth aspect above, a bending strength of the intermediate member may be equal to or more than 150 MPa and equal to or less than 400 MPa. This configuration has the same effect as that of the configuration according to the eleventh aspect.

In a thirties aspect of the technology disclosed herein according to any one of the eighteenth to twenty-nineth aspects, the intermediate member may comprise a plurality of intermediate members interposed between the lower plate member and the upper plate member in the up-down direction. The plurality of intermediate members may be aligned along the front-rear direction. This configuration has the same effect as that of the configuration according to the twelfth aspect.

In a thirty-first aspect of the technology disclosed herein according to any one of the eighteenth to thirties aspects above, the intermediate member may be constituted of ceramics including a transition metal or a poor metal. This configuration has the same effect as that of the configuration according to the thirteenth aspect.

In a thirty-second aspect of the technology disclosed herein according to the thirty-first aspect above, the ceramics may comprise non-oxide ceramics including the transition metal. This configuration has the same effect as that of the configuration according to the fourteenth aspect.

In a thirty-third aspect of the technology disclosed herein according to the thirty-second aspect above, the non-oxide ceramics may be TiB2, TiCN, or MoSi2. This configuration has the same effect as that of the configuration according to the fifteenth aspect.

In a thirty-fourth aspect of the technology disclosed herein according to the thirty-first aspect above, the ceramics may comprise oxide ceramics including the transition metal or the poor metal. This configuration has the same effect as that of the configuration according to the sixteenth aspect.

In a thirty-fifth aspect of the technology disclosed herein according to the thirty-fourth aspect above, the oxide ceramics may be Cr2O3, Al2O3, or Al6O13Si2. This configuration allows the intermediate member to have increased hardness, while suppressing thermal damage to the intermediate member. The configuration also allows for a reduction in the sliding resistance between the lower plate member and the intermediate member and allows the upper plate member to move easily above the lower plate member.

### First Embodiment

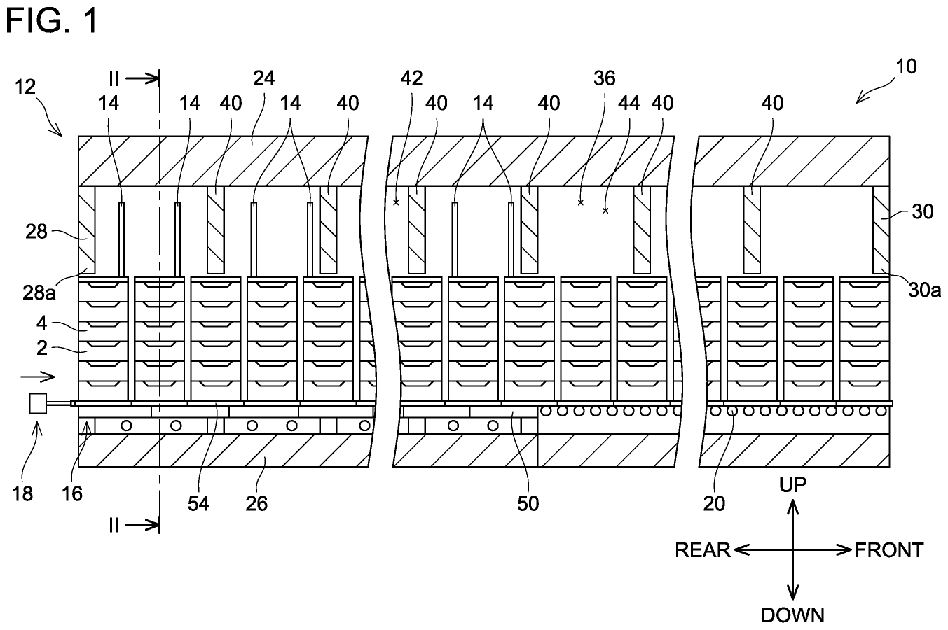

A heat treatment furnace 10 according to a first embodiment, shown in FIG. 1, heat-treats objects 2 to be treated. The objects 2 each include a saggar 4 and an actual object to be treated (not shown). The saggars 4 have a substantially cuboid box shape. The actual objects to be treated are housed in the saggars 4. The actual objects to be treated can be used for example as a raw material for ceramics capacitors, a material for positive electrodes of lithium-ion batteries, or a material for negative electrodes of lithium-ion batteries. Hereinafter, the longitudinal direction of the heat treatment furnace 10 will be termed a front-rear direction, a direction perpendicular to the front-rear direction will be termed a right-left direction, and a direction perpendicular to the front-rear direction and the right-left direction will be termed an up-down direction.

The heat treatment furnace 10 comprises a furnace body 12, a plurality of heaters 14, a sliding unit 16, a pusher 18, and conveyor rollers 20.

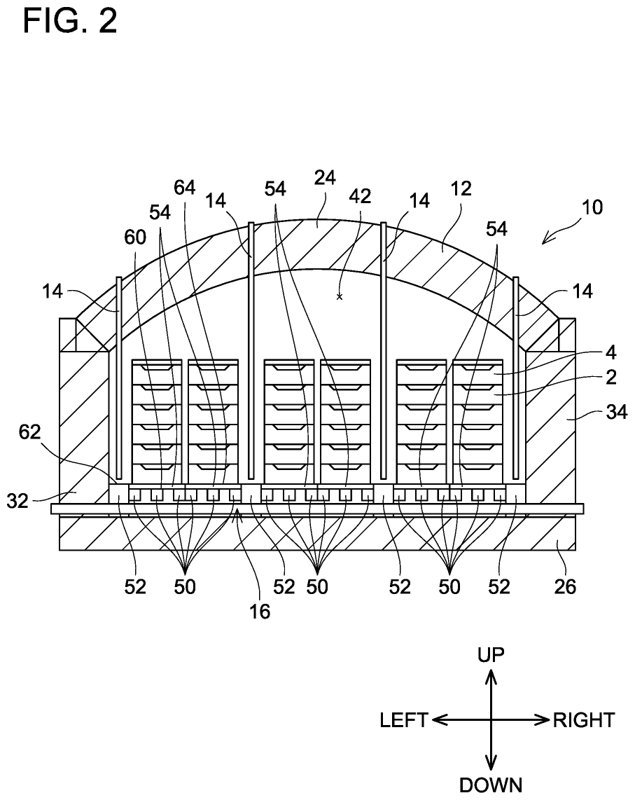

The furnace body 12 is a heat insulating structure that extends in the front-rear direction and has a substantially cuboid shape. The furnace body 12 comprises a ceiling wall 24, a bottom wall 26, a furnace entrance wall 28, a furnace exit wall 30, and side walls 32, 34. The ceiling wall 24, the bottom wall 26, the furnace entrance wall 28, the furnace exit wall 30, and the side walls 32, 34 define an internal space 36 of the furnace body 12. The ceiling wall 24 and the bottom wall 26 extend in the front-rear direction. The ceiling wall 24 is located above the bottom wall 26. The furnace entrance wall 28 is connected to a rear end of the ceiling wall 24 and a rear end of the bottom wall 26. The furnace entrance wall 28 has an inlet opening 28a penetrating the furnace entrance wall 28 in the front-rear direction. The internal space 36 communicates with the outside of the furnace body 12 through the inlet opening 28a. The furnace exit wall 30 is connected to a front end of the ceiling wall 24 and a front end of the bottom wall 26. The furnace exit wall 30 has an outlet opening 30a penetrating the furnace exit wall 30 in the front-rear direction. The internal space 36 communicates with the outside of the furnace body 12 through the outlet opening 30a. The outlet opening 30a is opposite to the inlet opening 28a in the front-rear direction. As shown in FIG. 2, the side walls 32, 34 are spaced apart from each other in the right-left direction. The side walls 32, 34 are connected to the ceiling wall 24, the bottom wall 26, the furnace entrance wall 28 (see FIG. 1), and the furnace exit wall 30 (see FIG. 1).

As shown in FIG. 1, the furnace body 12 further comprises a plurality of partition walls 40. The partition walls 40 are arranged along the front-rear direction. The partition walls 40 extend downward from the ceiling wall 24. The partition walls 40 partition the internal space 36 into a plurality of spaces.

The internal space 36 comprises a heat treatment space 42 and a cooling space 44. The heat treatment space 42 is defined by the ceiling wall 24, the bottom wall 26, the furnace entrance wall 28, the side walls 32, 34, and a partition wall 40 that is located at the border between the heat treatment space 42 and the cooling space 44. The heat treatment space 42 is located in a rear portion of the furnace body 12. The plurality of heaters 14 is disposed in the heat treatment space 42. The heaters 14 are arranged along the front-rear direction. The heat treatment space 42 is heated by the heaters 14 generating heat. The objects 2 in the heat treatment space 42 are thereby heated. The temperature in the heat treatment space 42 may be for example equal to or higher than 500 degrees, equal to or higher than 600 degrees, or equal to or higher than 700 degrees. Further, the temperature in the heat treatment space 42 may be for example equal to or lower than 1500 degrees, equal to or lower than 1400 degrees, or equal to or lower than 1300 degrees.

The cooling space 44 is located in a front portion of the furnace body 12. The cooling space 44 is defined by the ceiling wall 24, the bottom wall 26, the furnace exit wall 30, the side walls 32, 34, and the partition wall 40 that is located at the border between the cooling space 44 and the heat treatment space 42. At least one cooling pipe (not shown) is disposed in the cooling space 44. The cooling space 44 is cooled by water or air circulating through the at least one cooling pipe. The objects 2 in the cooling space 44 are thereby cooled.

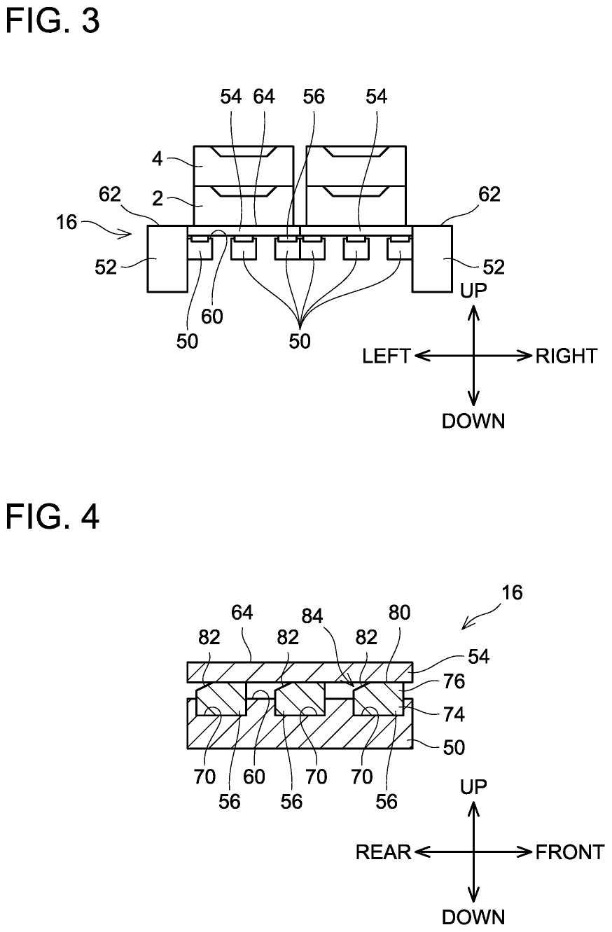

The sliding unit 16 is used to reduce sliding resistance when a heavy object, such as the plurality of objects 2, is conveyed (slid) under a high-temperature condition. The sliding unit 16 comprises a plurality of lower plate members 50, a plurality of guide members 52 (see FIG. 2), a plurality of upper plate members 54, and a plurality of intermediate members 56 (see FIG. 3). The plurality of lower plate members 50 is disposed in the heat treatment space 42. The lower plate members 50 have a plate shape extending in the front-rear direction. The lower plate members 50 are constituted of ceramics. The lower plate members 50 are arranged along the front-rear direction. As shown in FIG. 3, the lower plate members 50 are also arranged along the right-left direction. The lower plate members 50 each comprise an upper surface 60. The lower plate members 50 are oriented such that the upper surfaces 60 are perpendicular to the up-down direction, i.e., lie on a plane expanding in the front-rear direction and the right-left direction. The lower plate members 50 are oriented such that the upper surfaces 60 lie on the same plane.

The guide members 52 have a substantially cuboid shape extending in the front-rear direction. The guide members 52 are constituted of ceramics. As shown in FIG. 2, the guide members 52 are spaced apart from each other in the right-left direction. In this embodiment, six lower plate members 50 are disposed between each pair of guide members 52 adjacent in the right-left direction. The guide members 52 each comprise an upper surface 62. The guide members 52 are oriented such that the upper surfaces 62 are perpendicular to the up-down direction. The guide members 52 are oriented such that the upper surfaces 62 lie on the same plane. The upper surfaces 62 of the guide members 52 are positioned above the upper surfaces 60 of the lower plate members 50.

The upper plate members 54 correspond to conveyor plates. The upper plate members 54 have a flat plate shape. The upper plate members 54 are constituted of ceramics. The upper plate members 54 each comprise an upper surface 64. Each upper plate member 54 is configured to allow multiple objects 2 to be placed on its upper surface 64. In each upper plate member 54, the weight of objects 2 that can be placed on per unit area 1 m2 of the upper surface 64 is 600 kg or more. Multiple objects 2 (in this embodiment, six objects 2) are stacked in the up-down direction on each upper surface 64. Further, as shown in FIG. 3, stacks of objects 2 (in this embodiment, two stacks thereof) are placed on the upper surfaces 64 of two upper plate members 54, respectively. In a variant, stacks of objects 2 may be aligned along the front-rear direction on the upper surface 64 of each upper plate member 54. The objects 2 are placed on the upper surfaces 64.

The upper plate members 54 are positioned above the lower plate members 50. The upper plate members 54 face the upper surfaces 60 of the lower plate members 50 in the up-down direction. The upper plate members 54 are supported by the lower plate members 50 via the intermediate members 56. Multiple upper plate members 54 (in this embodiment, two upper plate members 54) are disposed between each pair of guide members 52 adjacent in the right-left direction. The total of widths of two upper plate members 54 in the right-left direction is slightly smaller than the interval between the guide members 52 adjacent in the right-left direction. One of the two upper plate members 54 contacts one of the guide members 52 from the right side, while the other upper plate member 54 contacts the other guide member 52 from the left side. The upper plate members 54 move forward in the internal space 36 of the furnace body 12 by being pushed by the pusher 18 (see FIG. 1). While the upper plate members 54 are moving in the heat treatment space 42, the objects 2 are heat treated. While the upper plate members 54 are moving in the cooling space 44, the objects 2 are cooled. The upper plate members 54 move above the lower plate members 50 while being guided forward by the guide members 52.

As shown in FIG. 3, the intermediate members 56 are interposed between the lower plate members 50 and the upper plate members 54 in the up-down direction. The intermediate members 56 have a substantially cuboid shape. The intermediate members 56 are attached to the lower plate members 50. The intermediate members 56 are supported by the lower plate members 50. The upper plate members 54 move above the lower plate members 50 while contacting the intermediate members 56.

As shown in FIG. 1, the pusher 18 is located outside the heat treatment furnace 10 and near the inlet opening 28a. The pusher 18 is configured to push the upper plate members 54 forward. In this embodiment, the pusher 18 simultaneously pushes forward six upper plate members 54 aligned along the right-left direction. Thus, the six upper plate members 54 are moved into the internal space 36 through the inlet opening 28a, and other upper plate members 54 within the internal space 36 are pushed forward by the entry of the six upper plate members 54. By the pusher 18 repeatedly pushing upper plate members 54, the upper plate members 54 are conveyed into the internal space 36 through the inlet opening 28a, move through the heat treatment space 42 and the cooling space 44 in this order, and then conveyed out of the furnace body 12 through the outlet opening 30a. Since the configuration of the pusher 18 is well known, detailed description for it is omitted.

The plurality of conveyor rollers 20 is disposed in the cooling space 44. The conveyor rollers 20 are constituted of for example a metal material or ceramics. The conveyor rollers 20 are spaced apart from each other in the front-rear direction. The ends of each conveyor roller 20 are rotatably supported by corresponding side walls 32, 34. When upper plate members 54 are pushed forward by the pusher 18, the conveyor rollers 20 rotate due to friction between the conveyor rollers 20 and upper plate members 54. In the cooling space 44, the upper plate members 54 move forward on the conveyor rollers 20.

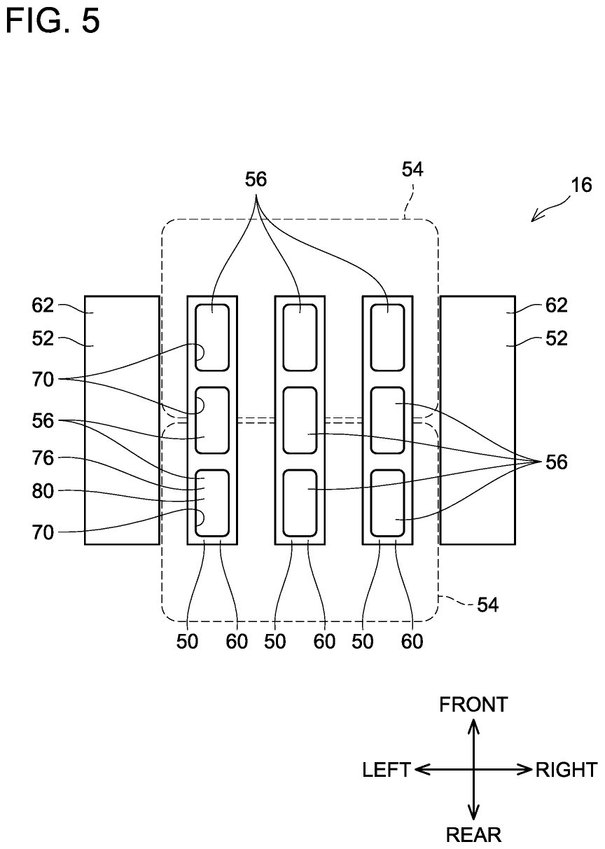

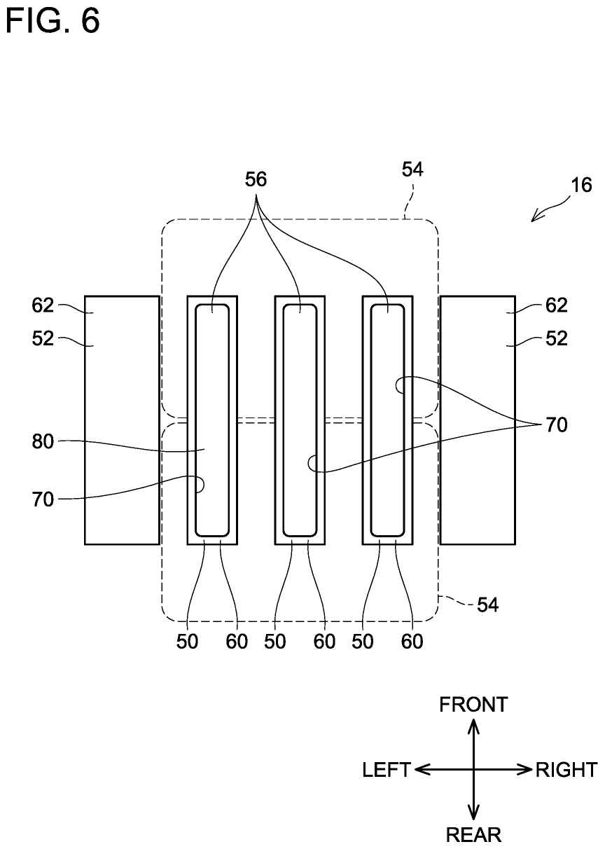

As shown in FIG. 4, each lower plate member 50 comprises a plurality of recesses 70 (in this embodiment, three recesses 70). The recesses 70 are recessed downward from the upper surface 60 of the lower plate member 50. The three recesses 70 are spaced apart from each other in the front-rear direction. The three recesses 70 are aligned along the front-rear direction. In a cross-sectional view of the lower plate member 50 along a plane extending in the front-rear direction and the up-down direction, the recesses 70 have a substantially rectangular shape elongated in the front-rear direction. Further, as shown in FIG. 5, the frontmost recess 70 is spaced apart from the front surface of the lower plate member 50, and the rearmost recess 70 is spaced apart from the rear surface of the lower plate member 50. The distance between the frontmost recess 70 and the front surface of the lower plate member 50 and the distance between the rearmost recess 70 and the rear surface of the lower plate member 50 may each be equal to or more than 5 mm or equal to or more than 10 mm. Further, the recesses 70 are spaced apart from both the left and right surfaces of the lower plate member 50. The distance between the recesses 70 and the left surface of the lower plate member 50 and the distance between the recesses 70 and the right surface of the lower plate member 50 are for example equal to or more than 5 mm and equal to or less than 20 mm. In the top view of the lower plate member 50, the recesses 70 have a substantially rectangular shape elongated in the front-rear direction. The total of widths of the recesses 70 in the front-rear direction is for example equal to or more than 50% and equal to or less than 95% of the width of the lower plate member 50 in the front-rear direction. The number of recesses 70 aligned along the front-rear direction is not limited to three, and may be for example two, or four or more. As shown in FIG. 6, in a variant, each lower plate member 50 comprises only a single recess 70. In this case, the recess 70 is elongated in the front-rear direction. Further, the width of the recess 70 in the front-rear direction is slightly smaller than the width of the lower plate member 50 in the front-rear direction.

As shown in FIG. 4, multiple intermediate members 56 (in this embodiment, three intermediate members 56) are attached to each lower plate member 50. The number of intermediate members 56 attached to a lower plate member 50 is the same as the number of recesses 70 defined in the lower plate member 50. The intermediate members 56 are supported in the recesses 70 by the lower plate member 50. The three intermediate members 56 are aligned along the front-rear direction. The total of widths of the multiple intermediate members 56 in the front-rear direction is for example equal to or more than 50% and equal to or less than 95% of the width of the lower plate member 50 in the front-rear direction. The number of intermediate members 56 aligned along the front-rear direction is not limited to three, and may be for example two, or four or more. As shown in FIG. 6, in a variant, only a single intermediate member 56 may be attached to each lower plate member 50. In this case, the intermediate member 56 is elongated in the front-rear direction. Further, the width of the intermediate member 56 in the front-rear direction is slightly smaller than the width of the lower plate member 50 in the front-rear direction.

The intermediate members 56 are constituted of ceramics. The type of ceramics for the intermediate members 56 is different from both the type of ceramics for the lower plate members 50 and the type of ceramics for the upper plate members 54. The ceramics for the intermediate members 56 includes a transition metal or a poor metal. The ceramics for the intermediate members 56 comprises for example non-oxide ceramics including a transition metal. The non-oxide ceramics including a transition metal may for example be TiB2, TiCN, or MoSi2. Alternatively, the ceramics for the intermediate members 56 may comprise for example oxide ceramics including a transition metal or a poor metal. The oxide ceramics including a transition metal or a poor metal may for example be Cr2O3, Al₂O3, or Al6O13Si2. This increases the hardness of the intermediate members 56 and also reduces the sliding resistance between the upper plate members 54 and the intermediate members 56 while maintaining the heat resistance and wear resistance of the intermediate members 56.

A porosity of the intermediate members 56 is smaller than both a porosity of the lower plate members 50 and a porosity of the upper plate members 54. In the disclosure herein, a porosity means an apparent porosity. An apparent porosity is calculated by multiplying 100 by a value that is obtained by dividing the total volume of pores communicating with the outside of a member by the volume of the member including the pores. The porosity of the intermediate members 56 may be for example equal to or less than 1%, equal to or less than 0.5%, or equal to or less than 0.1%. This means that there is less pore formation in surfaces of the intermediate members 56 and thus the surfaces of the intermediate members 56 are smooth, and also the intermediate members 56 achieve increased strength.

A bending strength of the intermediate members 56 is greater than a bending strength of the lower plate members 50 and a bending strength of the upper plate members 54. In the disclosure herein, a bending strength means a four-point bending strength. In a four-point bending test, a member is supported from below in the vicinity of its opposing ends and a central portion of the member is pressed downward at two points, and the four-point bending strength of the member is calculated by using the load under which the member is broken. The bending strength of the intermediate members 56 may be for example equal to or more than 150 MPa (150×106 N/m2), equal to or more than 200 MPa (200×106 N/m2), or equal to or more than 250 MPa (250×106 N/m2). Further, the bending strength of the intermediate members 56 may be for example equal to or less than 400 MPa (400×106 N/m2), equal to or less than 350 MPa (350×106 N/m2), or equal to or less than 300 MPa (300×106 N/m2). This suppresses the intermediate members 56 from being damaged by the weight of the upper plate member 54 and the weight of objects 2 placed on the upper plate member 54. For example, the bending strength of the intermediate members 56 is equal to or more than 150 MPa and equal to or less than 400 MPa, equal to or more than 200 MPa and equal to or less than 359 MPa, or equal to or more than 250 MPa and equal to or less than 300 MPa.

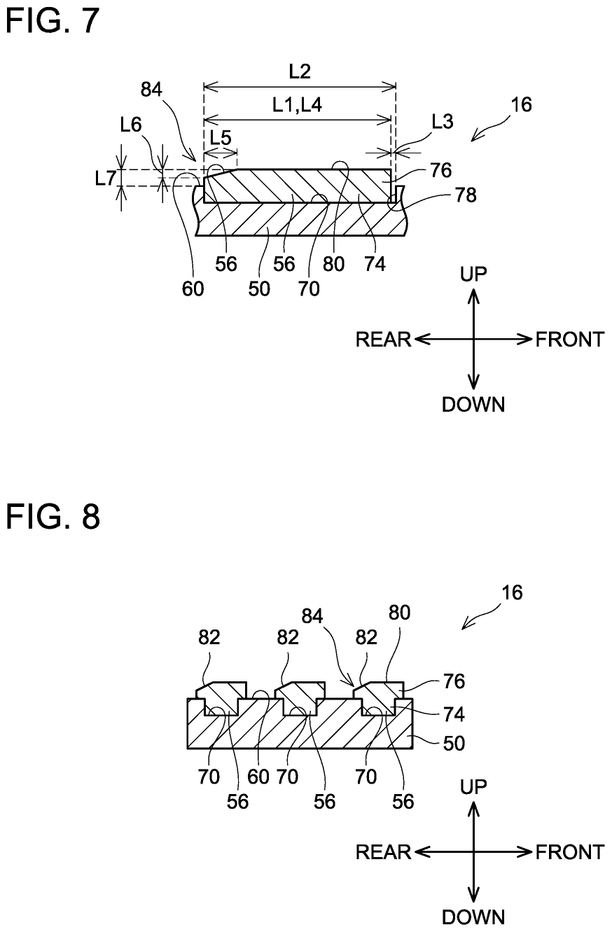

As shown in FIG. 7, each intermediate member 56 comprises a received portion 74 and a protruding portion 76. The received portion 74 is received in the recess 70. The received portion 74 is disposed within the recess 70. The received portion 74 has a shape corresponding to the shape of the recess 70. The length of the received portion 74 in the up-down direction is for example equal to or more than 5 mm and equal to or less than 20 mm. A length L1 of the received portion 74 in the front-rear direction is shorter than a length L2 of the recess 70 in the front-rear direction. Thus, there is a clearance 78 in the recess 70 in the front-rear direction. Even when the thermal expansion coefficient of the intermediate member 56 is greater than that of the lower plate member 50, the received portion 74 can thermally expand in the front-rear direction within the recess 70 since the clearance 78 gives a room for expansion. Therefore, the intermediate member 56 is suppressed from being pressed against the lower plate member 50 and thus thermal stress between the intermediate member 56 and the lower plate member 50 is reduced. This suppresses damage to the intermediate member 56 and the lower plate member 50. A length L3 of the clearance 78 in the front-rear direction is equal to the value obtained by subtracting the length L1 from the length L2. The length L3 is equal to or less than 2% of the length L2, may be equal to or less than 1% of the length L2, or be equal to or less than 0.5% of the length L2. This suppresses damage to the intermediate member 56 and the lower plate member 50 caused by thermal expansion, and also suppresses wear of the intermediate member 56 because an area of the intermediate member 56 that is subjected to a load is maintained sufficiently large.

As shown in FIG. 4, the protruding portion 76 is connected to the upper end of the received portion 74. The protruding portion 76 extends upward from the received portion 74. The protruding portion 76 protrudes beyond the upper surface 60 of the lower plate member 50 toward the upper plate member 54. The protruding portion 76 is positioned outside the lower plate member 50. The protruding portion 76 has a substantially cuboid shape. The length of the protruding portion 76 in the up-down direction is for example equal to or more than 5 mm and equal to or less than 20 mm. The length of the protruding portion 76 in the up-down direction is substantially equal to the length of the received portion 74 in the up-down direction. As shown in FIG. 7, a length L4 of the protruding portion 76 in the front-rear direction is substantially equal to the length L1 of the received portion 74 in the front-rear direction. As shown in FIG. 8, in a variant, the length L4 may be longer than the length L1. In this case, a part of lower surface of the protruding portion 76 contacts the upper surface 60 of the lower plate member 50.

As shown in FIG. 7, the protruding portion 76 comprises an upper surface 80. The upper surface 80 corresponds to the upper surface of the intermediate member 56. The upper surface 80 faces the upper plate member 54 in the up-down direction. The upper surface 80 contacts the upper plate member 54 in surface contact. The upper plate member 54 slides forward on the upper surface 80. The upper surface 80 may or may not be polished. The arithmetic average roughness of the upper surface 80 is for example equal to or less than 10 micrometers, may be equal to or less than 5 micrometers, or be equal to or less than 2 micrometers. This allows the upper plate member 54 to slide smoothly on the upper surface 80. The arithmetic average roughness of the upper surface 80 may be equal to or less than 1 micrometer.

A coefficient of dynamic friction of the upper surface 80 of the intermediate member 56 to the upper plate member 54 is for example equal to or less than 0.5, may be equal to or less than 0.4, or be equal to or less than 0.35. This allows the upper plate member 54 to slide smoothly on the upper surface 80. The coefficient of dynamic friction of the upper surface 80 of the intermediate member 56 to the upper plate member 54 may be equal to or less than 0.3.

The sliding resistance between the upper plate member 54 and the intermediate members 56 is smaller than the sliding resistance between the upper plate member 54 and the lower plate members 50. Therefore, the upper plate member 54 can move forward smoothly as compared to a configuration in which the intermediate members 56 are not interposed between the upper plate member 54 and the lower plate members 50.

As shown in FIG. 7, the protruding portion 76 comprises a chamfer 82. The chamfer 82 is located at a corner 84 at the rear end of the protruding portion 76. The chamfer 82 is formed by chamfering the rear end of the protruding portion 76. In a variant, the chamfer 82 may be formed by rounding the rear end of the protruding portion 76. The chamfer 82 is continuous with the upper surface 80. A length L5 of the chamfer 82 in the front-rear direction is for example in the range from 10 mm to 20 mm. A length L6 of the chamfer 82 in the up-down direction is for example in the range from 1 mm to 3 mm. The length L5 is equal to or more than three times the length L6, or may be equal to or five times the length L6. Further, the length L5 is equal to or less than 20 times the length L6, or may be equal to or less than 10 times the length L6. The chamfer 82 allows the upper plate member 54 to slide forward on the upper surface 80 of the protruding portion 76 without getting caught on the corner 84 of the protruding portion 76. For example, the length L5 is equal to or more than three times the length L6 and equal to or less than 20 times the length L6, or equal to or more than five times the length L6 and equal to or less than 10 times the length L6. Further, the length L5 is equal to or more than 5% of the length L4 of the protruding portion 76 in the front-rear direction, or may be equal to or more than 15% thereof. The length L6 is equal to or less than 50% of a length L7 of the protruding portion 76 in the up-down direction.

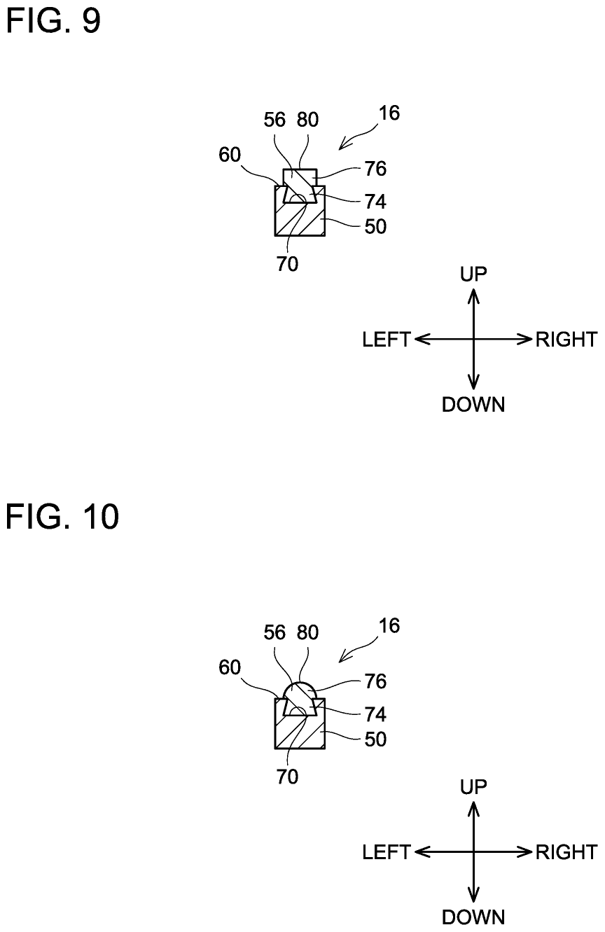

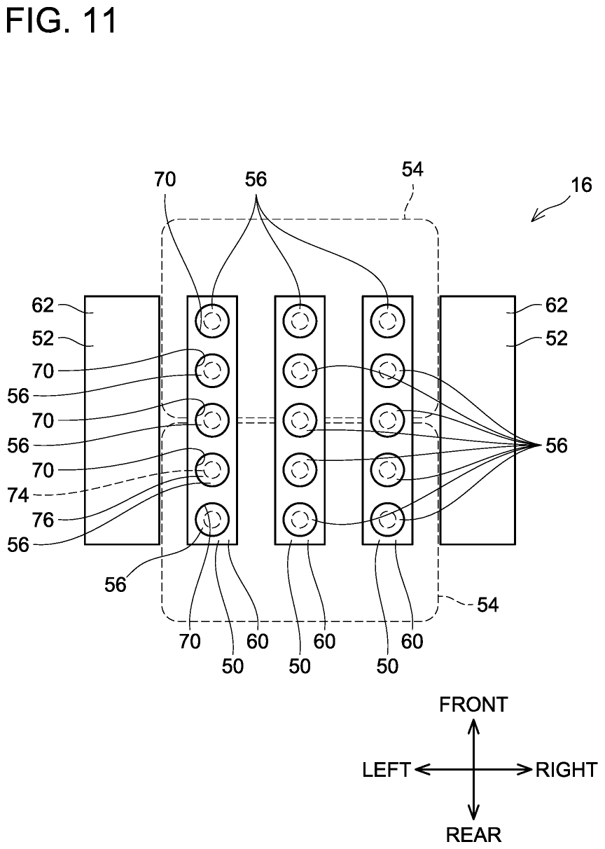

The shapes of the received portion 74 and the protruding portion 76 are not limited to those described above. For example, as shown in FIG. 9, in a cross-sectional view of an intermediate member 56 along a plane extending in the up-down direction and the right-left direction, the received portion 74 may have a substantially trapezoidal shape and the protruding portion 76 may have a substantially rectangular shape. In this case, in a cross-sectional view of the intermediate member 56 along a plane extending in the up-down direction and the right-left direction, the recess 70 of the lower plate member 50 has a shape corresponding to the shape of the received portion 74 (i.e., substantially trapezoidal shape). The intermediate member 56 is attached to the lower plate member 50 by moving the intermediate member 56 in the front-rear direction relative to the lower plate member 50. Alternatively, as shown in FIG. 10, in a cross-sectional view of an intermediate member 56 along a plane extending in the up-down direction and the right-left direction, the received portion 74 may have a substantially trapezoidal shape and the protruding portion 76 may have a substantially semicircular shape. In this case, in a cross-sectional view of the intermediate member 56 along a plane extending in the up-down direction and the right-left direction, the recess 70 of the lower plate member 50 has a shape corresponding to the shape of the received portion 74 (i.e., substantially trapezoidal shape). The intermediate member 56 is attached to the lower plate member 50 by moving the intermediate member 56 in the front-rear direction relative to the lower plate member 50. Alternatively, as shown in FIG. 11, the received portion 74 and the protruding portion 76 may have substantially cylindrical shapes, respectively. In FIG. 11, the received portions 74 are depicted by broken lines. In this case, the diameter of outer circumference of the received portion 74 is smaller than the diameter of outer circumference of the protruding portion 76. Further, the recess 70 of the lower plate member 50 has a shape corresponding to the shape of the received portion 74 (i.e., substantially cylindrical shape). The intermediate member 56 is attached to the lower plate member 50 by inserting the intermediate member 56 into the recess 70 of the lower plate member 50 from above.

In the first embodiment, the upper surface 60 of the lower plate member 50 is an example of “first facing surface”. The upper surface 80 of the protruding portion 76 is an example of “second facing surface”.

### Second Embodiment

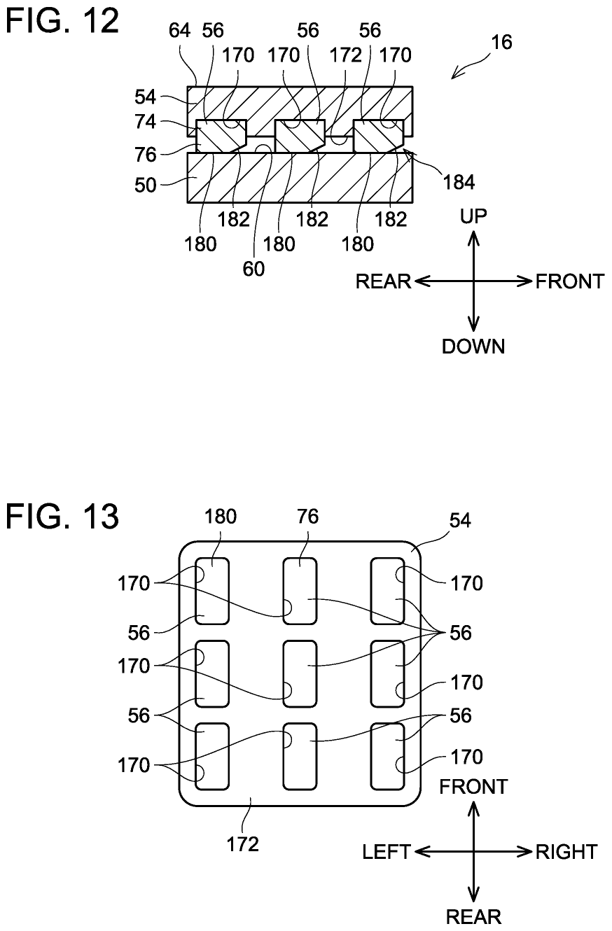

A second embodiment is described. For the second embodiment, only the differences from the first embodiment are described. In the second embodiment, as shown in FIG. 12, intermediate members 56 are attached to upper plate members 54. The material, porosity, and bending strength of the intermediate members 56 in the second embodiment are substantially the same as those of the intermediate members 56 in the first embodiment, respectively. Lower plate members 50 do not include recesses 70.

As shown in FIG. 13, each upper plate member 54 comprises a plurality of recesses 170 (in this embodiment, nine recesses 170). The recesses 170 are recessed upward from a lower surface 172 of the upper plate member 54. The lower surface 172 faces upper surfaces 60 (see FIG. 12) of the lower plate members 50. Three recesses 170 are spaced apart from each other in the front-rear direction. The three recesses 170 are aligned along the front-rear direction. Three groups each including such three recesses 170 are arranged spaced apart from each other in the right-left direction. The frontmost recesses 170 are spaced apart from the front surface of the upper plate member 54, the rearmost recesses 170 are spaced apart from the rear surface of the upper plate member 54. The distance between the frontmost recesses 170 and the front surface of the upper plate member 54 and the distance between the rearmost recesses 170 and the rear surface of the upper plate member 54 are each equal to or more than 5 mm, or may be equal to or more than 10 mm. Further, the leftmost recesses 170 are spaced apart from the left surface of the upper plate member 54, and the rightmost recesses 170 are spaced apart from the right surface of the upper plate member 54. The distance between the leftmost recesses 170 and the left surface of the upper plate member 54 and the distance between the rightmost recesses 170 and the right surface of the upper plate member 54 are each for example equal to or more than 5 mm and equal to or less than 20 mm. The shape of the recesses 170 is substantially the same as the shape of the recesses 70 in the first embodiment, and dimensions of the recesses 170 are substantially the same as the dimensions of the recesses 70 in the first embodiment. The total of widths of the recesses 170 in the front-rear direction is for example equal to or more than 50% and equal to or less than 95% of the width of the upper plate member 54 in the front-rear direction. The number of recesses 170 aligned along the front-rear direction and the number of recesses 170 aligned along the right-left direction are not limited to three, and for example may be two or less, or four or more.

Multiple intermediate members 56 (in this embodiment, nine intermediate members 56) are attached to each upper plate member 54. The number of intermediate members 56 attached to an upper plate member 54 is the same as the number of recesses 170 defined in the upper plate member 54. The intermediate members 56 are attached to the upper plate member 54 via an adhesive. Three intermediate members 56 are spaced apart from each other in the front-rear direction. The three intermediate members 56 are aligned along the front-rear direction. Three groups each including such three intermediate members 56 are arranged spaced apart from each other in the right-left direction. The total of widths of intermediate members 56 in the front-rear direction is for example equal to or more than 50% and equal to or less than 95% of the width of the upper plate member 54 in the front-rear direction. The number of intermediate members 56 aligned along the front-rear direction and the number of intermediate members 56 aligned along the right-left direction are not limited to three, and for example may be two or less, or four or more.

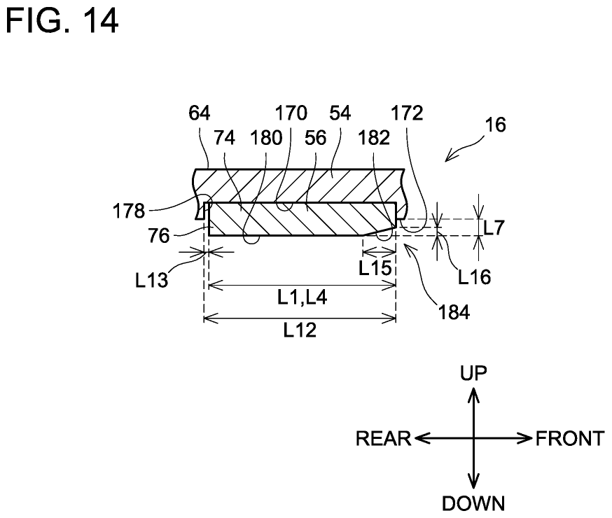

As shown in FIG. 14, a received portion 74 of the intermediate member 56 is received within the recesses 170. The received portion 74 has a shape corresponding to the shape of the recess 170. A length L1 of the received portion 74 in the front-rear direction is shorter than a length L12 of the recess 170 in the front-rear direction. The length L12 of the recess 170 in the front-rear direction is substantially the same as the length L2 of the recess 70 in the front-rear direction according to the first embodiment. Thus, a clearance 178 is provided in the recess 170 in the front rear direction. Therefore, even when the thermal expansion coefficient of the intermediate member 56 is greater than that of the upper plate member 54, the received portion 74 can thermally expand in the front-rear direction within the recess 170. Therefore, the intermediate member 56 can be suppressed from being pressed against the upper plate member 54 due to thermal expansion and thus thermal stress between the intermediate member 56 and the upper plate member 54 can be reduced. This suppresses damage to the intermediate member 56 and the upper plate member 54. A length L13 of the clearance 178 in the front-rear direction is equal to the value obtained by subtracting the length L1 from the length L12. The length L13 is substantially the same as the length L3 of the clearance 78 in the front-rear direction according to the first embodiment. The length L13 is equal to or less than 2% of the length L12, may be equal to or less than 1% of the length L12, or be equal to or less than 0.5% of the length L12. This suppresses damage to the intermediate member 56 and the upper plate member 54 caused by thermal expansion, and also suppresses wear of the intermediate member 56 because an area of the intermediate member 56 that is subjected to a load is maintained sufficiently large.

A protruding portion 76 of the intermediate member 56 is connected to the lower end of the received portion 74. The protruding portion 76 extends downward from the received portion 74. The protruding portion 76 protrudes beyond a lower surface 172 of the upper plate member 54 toward the lower plate member 50 (see FIG. 12). The protruding portion 76 is located outside the upper plate member 54. A length L4 of the protruding portion 76 in the front-rear direction is substantially equal to the length L1 of the received portion 74 in the front-rear direction. In a variant, the length L4 may be longer than the length L1. That is, the shape of the intermediate member 56 is substantially the same as the shape of the intermediate member 56 shown in FIG. 8. In this case, a part of upper surface of the protruding portion 76 contacts the lower surface 172 of the upper plate member 54.

The protruding portion 76 comprises a lower surface 180. The lower surface 180 corresponds to the lower surface of the intermediate member 56. The lower surface 180 faces the lower plate member 50 in the up-down direction. The lower surface 180 contacts the lower plate member 50 in surface contact. The intermediate member 56 slides forward on the upper surface 60 of the lower plate member 50. The lower surface 180 may or may not be polished. The arithmetic average roughness of the lower surface 180 is for example equal to or less than 10 micrometers, may be equal to or less than 5 micrometers, or be equal to or less than 2 micrometers. This allows the intermediate member 56 to slide smoothly on the upper surface 60 of the lower plate member 50. The arithmetic average roughness of the lower surface 180 may be equal to or less than 1 micrometer.

A coefficient of dynamic friction of the lower surface 180 of the intermediate member 56 to the lower plate member 50 is for example equal to or less than 0.5, may be equal to or less than 0.4, or be equal to or less than 0.35. This allows the intermediate member 56 to slide smoothly on the upper surface 60 of the lower plate member 50. The coefficient of dynamic friction of the lower surface 180 of the intermediate member 56 to the lower plate member 50 may be equal to or less than 0.3.

The sliding resistance between the lower plate members 50 and the intermediate members 56 is smaller than the sliding resistance between the upper plate member 54 and the lower plate members 50. Therefore, the intermediate members 56 can move forward smoothly together with the upper plate member 54, as compared to a configuration in which the intermediate members 56 are not interposed between the upper plate member 54 and the lower plate members 50.

The protruding portion 76 comprises a chamfer 182. The chamfer 182 is located at a corner 184 at the front end of the protruding portion 76. The chamfer 182 is formed by chamfering the front end of the protruding portion 76. In a variant, the chamfer 182 may be formed by rounding the front end of the protruding portion 76. The chamfer 182 is continuous with the lower surface 180. A length L15 of the chamfer 182 in the front-rear direction is for example in the range from 10 mm to 20 mm. A length L16 of the chamfer 182 in the up-down direction is for example in the range from 1 mm to 3 mm. The length L15 is equal to or more than three times the length L16, or may be equal to or more than five times the length L16. Further, the length L15 is equal to or less than 20 times the length L16, or may be equal to or less than 10 times the length L16. The chamfer 182 allows the intermediate member 56 to slide forward on the upper surface 60 of the lower plate member 50 without the lower plate member 50 getting caught on the corner 184 of the protruding portion 76. For example, the length L15 is equal to or more than three times the length L16 and equal to or less than 20 times the length L16, or equal to or more than five times the length L16 and equal to or less than 10 times the length L16. Further, the length L15 is equal to or more than 5% of the length L4 of the protruding portion 76 in the front-rear direction, or may be equal to or more than 15% thereof. The length L16 is equal to or less than 50% of the length L7 of the protruding portion 76 in the up-down direction.

The shapes of the received portion 74 and the protruding portion 76 are not limited to those described above. For example, in a cross-sectional view of an intermediate member 56 along a plane extending in the up-down direction and the right-left direction, the received portion 74 may have a substantially trapezoidal shape and the protruding portion 76 may have a substantially rectangular shape. That is, the intermediate member 56 may have substantially the same shape as that of the intermediate member 56 shown in FIG. 9. The intermediate member 56 is attached to the upper plate member 54 by moving the intermediate member 56 in the front-rear direction relative to the upper plate member 54. Alternatively, in a cross-sectional view of an intermediate member 56 along a plane extending in the up-down direction and the right-left direction, the received portion 74 may have a substantially trapezoidal shape and the protruding portion 76 may have a substantially semicircular shape. That is, the intermediate member 56 may have substantially the same shape as that of the intermediate member 56 shown in FIG. 10. The intermediate member 56 is attached to the upper plate member 54 by moving the intermediate member 56 in the front-rear direction relative to the upper plate member 54. Alternatively, the received portion 74 and the protruding portion 76 may have substantially cylindrical shapes, respectively. That is, the intermediate member 56 may have substantially the same shape as that of the intermediate member 56 shown in FIG. 11. The intermediate member 56 is attached to the upper plate member 54 by inserting the intermediate member 56 into the recess 170 of the upper plate member 54 from below.

In the second embodiment, the lower surface 172 of the upper plate member 54 is an example of “first facing surface”. The lower surface 180 of the protruding portion 76 is an example of “second facing surface”.

### Third Embodiment

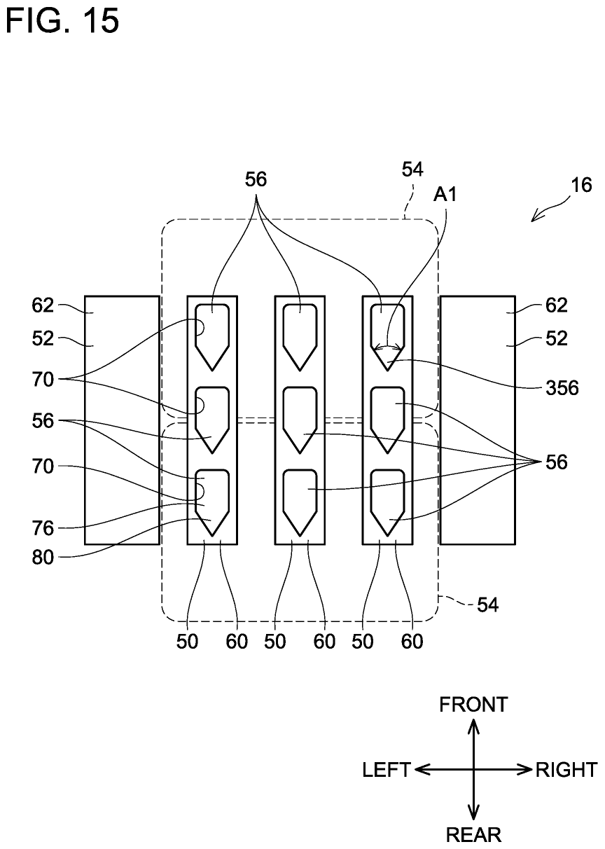

A third embodiment is described. For the third embodiment, only the differences from the first embodiment will be described. As shown in FIG. 15, each intermediate member 56 comprises a pointed portion 356. The pointed portion 356 is located in a rear portion of the intermediate member 56. In a plan view, the pointed portion 356 has a pointed shape. The width of the pointed portion 356 in the right-left direction is gradually increased toward the front. With an angle A1 between left and right surfaces of the pointed portion 356 being small, the pointed portion 356 is vulnerable to damage, while with the angle A1 being large, foreign matters such as wear debris cannot easily move along the pointed portion 356. Therefore, damage to the pointed portion 356 is suppressed for example with the angle A1 of 60 degrees or more. Further, with the angle A1 of 120 degrees or less, foreign matters such as wear debris can easily move forward along the pointed portion 356 and thus accumulation of the foreign matters at the rear end of the intermediate member 56 can be suppressed. The angle A1 may be for example equal to or more than 60 degrees and equal to or less than 90 degrees.

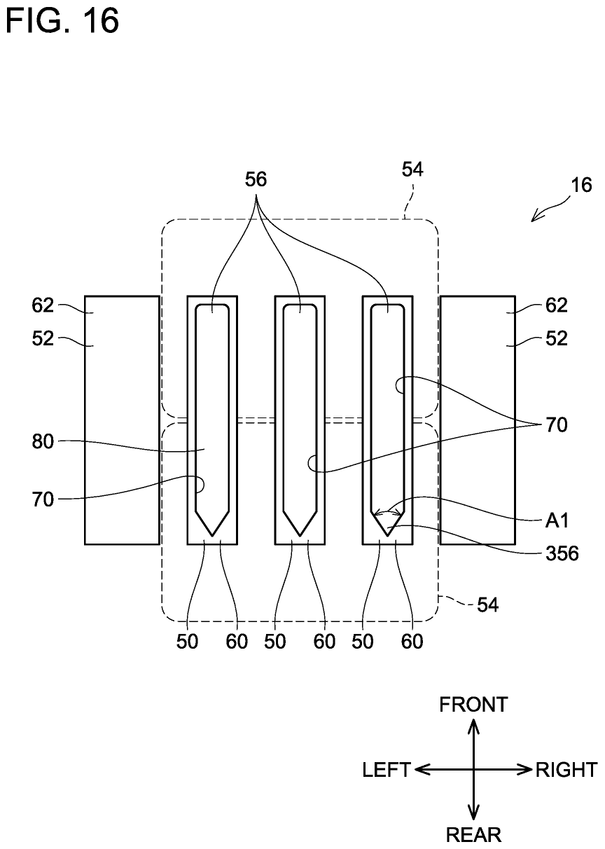

In a variant, in the configuration in which only a single intermediate member 56 is attached to each lower plate member 50 as shown in FIG. 16, the pointed portion 356 may be located in the rear portion of the intermediate member 56.

### Fourth Embodiment

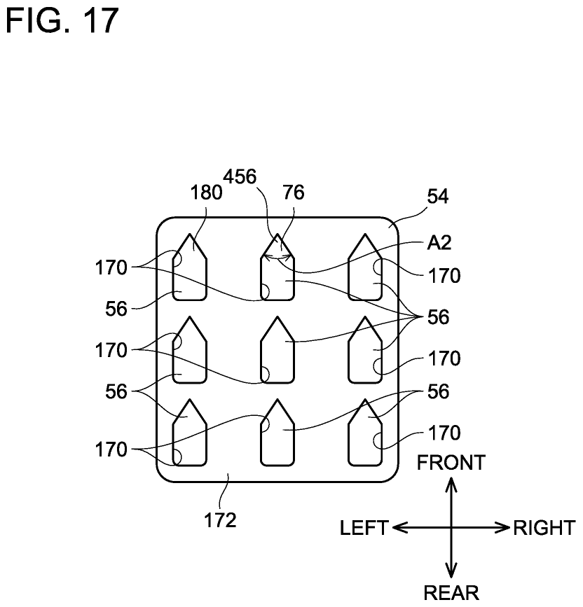

A fourth embodiment is described. For the fourth embodiment, only the differences from the second embodiment will be described. As shown in FIG. 17, each intermediate member 56 comprises a pointed portion 456. The pointed portion 456 is located in a front portion of the intermediate member 56. In a plane view, the pointed portion 456 has a pointed shape. The width of the pointed portion 456 in the right-left direction is gradually increased toward the rear. With an angle A2 between left and right surfaces of the pointed portion 456 being small, the pointed portion 456 is vulnerable to damage, while with the angle A2 being large, foreign matters such as wear debris cannot easily move along the pointed portion 456. Therefore, damage to the pointed portion 456 is suppressed for example with the angle A2 of 60 degrees or more. Further, with the angle A2 of 120 degrees or less, foreign matters such as wear debris can easily move rearward along the pointed portion 456 and thus accumulation of the foreign matters at the front end of the intermediate member 56 can be suppressed. The angle A2 may be for example equal to or more than 60 degrees and equal to or less than 90 degrees.

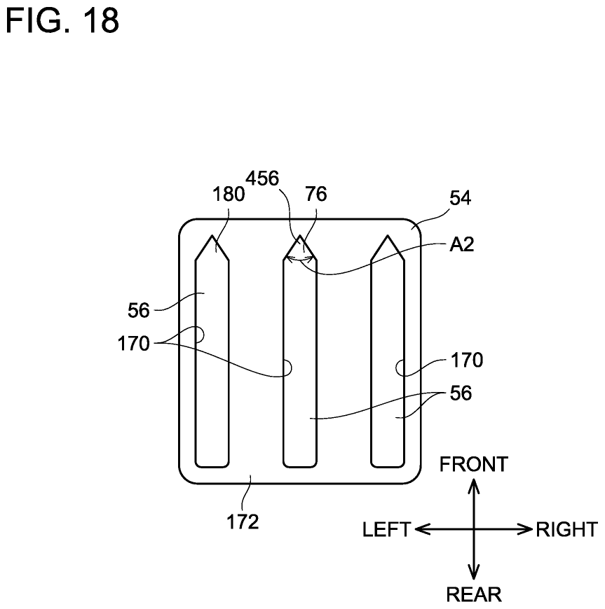

In a variant, in the configuration in which three intermediate members 56 are aligned along the right-left direction and attached to an upper plate member 54 as shown in FIG. 18, the pointed portion 456 may be located in the front portion of each of the intermediate members 56.

### Fifth Embodiment

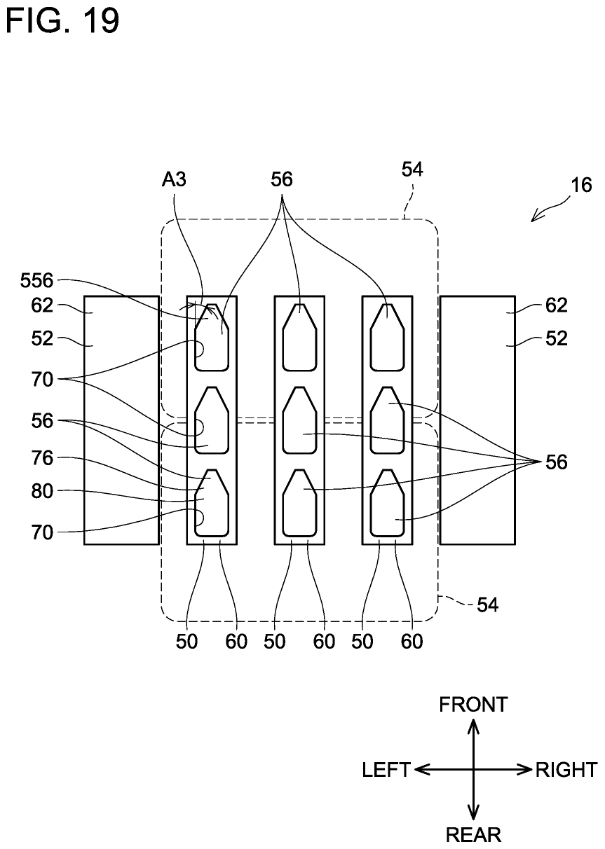

A fifth embodiment is described. For the fifth embodiment, only the differences from the first embodiment will be described. As shown in FIG. 19, each intermediate member 56 comprises a tapered portion 556. The tapered portion 556 is located in a front portion of the intermediate member 56. In a top view of the intermediate member 56, the tapered portion 556 has a substantially trapezoidal shape. The width of the tapered portion 556 in the right-left direction is gradually increased toward the rear. A taper angle A3 of the tapered portion 556 is a half of the angle between left and right surfaces of the tapered portion 556. The taper angle A3 is for example equal to or more than 10 degrees and equal to or less than 45 degrees. The taper angle A3 of 10 degrees or more helps foreign matters such as wear debris on the upper surface of the intermediate member 56 to fall off from the upper surface of the intermediate member 56 to the right and left sides of the intermediate member 56. The taper angle A3 of 45 degrees or less makes the length of the tapered portion 556 in the front-rear direction longer than that in a configuration in which the taper angle A3 exceeds 45 degrees, and thus helps foreign matters to fall off from the upper surface to the intermediate member 56.

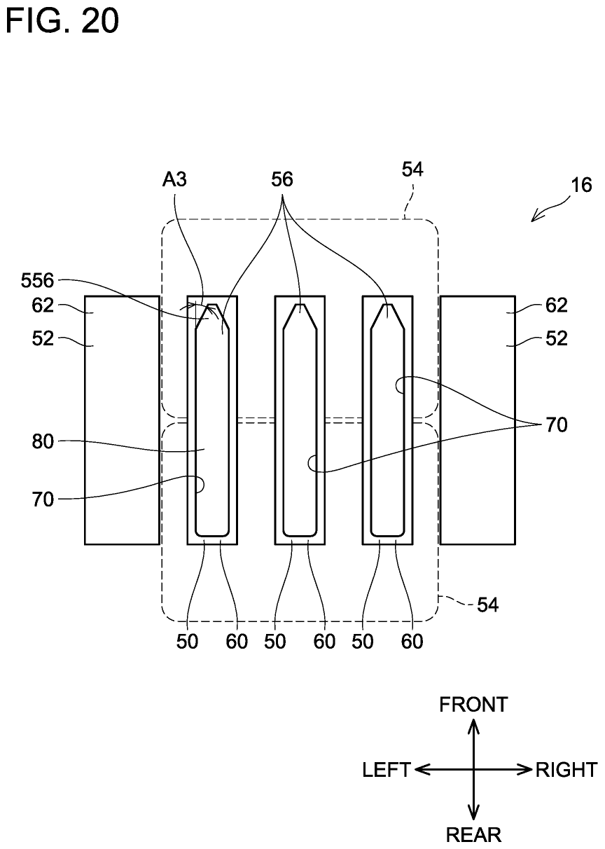

In a variant, in the configuration in which only a single intermediate member 56 is attached to each lower plate member 50 as shown in FIG. 20, the tapered portion 556 may be located in the front portion of the intermediate member 56.

### (Variant)

In an embodiment, a plurality of intermediate members 56 may be disposed in a single recess 70, 170. In this case, the intermediate members 56 may contact each other in the front-rear direction.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment furnace configured to heat-treat a plurality of objects, the heat treatment furnace comprising:
a furnace body comprising an entrance and an exit;
a lower plate member disposed in the furnace body;
an upper plate member disposed above the lower plate member, wherein the upper plate member is configured to allow the plurality of objects stacked in an up-down direction to be placed thereon;
an intermediate member interposed between the lower plate member and the upper plate member in the up-down direction and attached to the lower plate member; and
a pusher configured to push the upper plate member forward from the entrance toward the exit,
wherein
the upper plate member moves forward above the lower plate member, and
a sliding resistance between the upper plate member and the intermediate member is smaller than a sliding resistance between the upper plate member and the lower plate member.

2. The heat treatment furnace according to claim 1, wherein a coefficient of dynamic friction of the intermediate member to the upper plate member is equal to or less than 0.5.

3. The heat treatment furnace according to claim 1, wherein
the lower plate member comprises:
a first facing surface facing the upper plate member; and
a recess recessed from the first facing surface, and
the intermediate member comprises:
a received portion received in the recess; and
a protruding portion protruding beyond the first facing surface toward the upper plate member.

4. The heat treatment furnace according to claim 3, wherein the protruding portion comprises a chamfer at a corner of a rear end of the protruding portion.

5. The heat treatment furnace according to claim 4, wherein a length of the chamfer in a front-rear direction is equal to or more than three times a length of the chamfer in the up-down direction and equal to or less than 20 times the length of the chamfer in the up-down direction.

6. The heat treatment furnace according to claim 3, wherein a length of the received portion in a front-rear direction is less than a length of the recess in the front-rear direction.

7. The heat treatment furnace according to claim 6, wherein a length obtained by subtracting the length of the received portion in the front-rear direction from the length of the recess in the front-rear direction is equal to or less than 2% of the length of the recess in the front-rear direction.

8. The heat treatment furnace according to claim 3, wherein
the protruding portion comprises a second facing surface facing the upper plate member, and
an arithmetic average roughness of the second facing surface is equal to or less than 10 micrometers.

9. The heat treatment furnace according to claim 1, wherein a porosity of the intermediate member is equal to or less than 1%.

10. The heat treatment furnace according to claim 9, wherein the porosity of the intermediate member is less than both of a porosity of the upper plate member and a porosity of the lower plate member.

11. The heat treatment furnace according to claim 10, wherein a bending strength of the intermediate member is equal to or more than 150 MPa and equal to or less than 400 MPa.

12. The heat treatment furnace according to claim 1, wherein
the intermediate member comprises a plurality of intermediate members interposed between the lower plate member and the upper plate member in the up-down direction, and
the plurality of intermediate members is aligned along a front-rear direction.

13. The heat treatment furnace according to claim 1, wherein the intermediate member is constituted of ceramics including a transition metal or a poor metal.

14. The heat treatment furnace according to claim 13, wherein the ceramics comprises non-oxide ceramics including the transition metal.

15. The heat treatment furnace according to claim 14, wherein the non-oxide ceramics is TiB2, TiCN, or MoSi2.

16. The heat treatment furnace according to claim 13, wherein the ceramics comprises oxide ceramics including the transition metal or the poor metal.

17. The heat treatment furnace according to claim 16, wherein the oxide ceramics is Cr2O3, Al₂O3, or Al6O13Si2.

18. A heat treatment furnace configured to heat-treat a plurality of objects, the heat treatment furnace comprising:
a furnace body comprising an entrance and an exit;
a lower plate member disposed in the furnace body;
an upper plate member disposed above the lower plate member, wherein the upper plate member is configured to allow the plurality of objects stacked in an up-down direction to be placed thereon;
an intermediate member interposed between the lower plate member and the upper plate member in the up-down direction and attached to the upper plate member; and
a pusher configured to push the upper plate member forward from the entrance toward the exit,
wherein
the upper plate member moves forward above the lower plate member, and
a sliding resistance between the lower plate member and the intermediate member is smaller than a sliding resistance between the lower plate member and the upper plate member.

19. The heat treatment furnace according to claim 18, wherein a coefficient of dynamic friction of the intermediate member to the lower plate member is equal to or less than 0.5.

20. The heat treatment furnace according to claim 18, wherein
the upper plate member comprises:
a first facing surface facing the lower plate member; and
a recess recessed from the first facing surface, and
the intermediate member comprises:
a received portion received in the recess; and
a protruding portion protruding beyond the first facing surface toward the lower plate member.

21. The heat treatment furnace according to claim 20, wherein the protruding portion comprises a chamfer at a corner of a front end of the protruding portion.

22. The heat treatment furnace according to claim 21, wherein a length of the chamfer in a front-rear direction is equal to or more than three times a length of the chamfer in the up-down direction and equal to or less than 20 times the length of the chamfer in the up-down direction.

23. The heat treatment furnace according to claim 20, wherein a length of the received portion in a front-rear direction is less than a length of the recess in the front-rear direction.

24. The heat treatment furnace according to claim 23, wherein a length obtained by subtracting the length of the received portion in the front-rear direction from the length of the recess in the front-rear direction is equal to or less than 2% of the length of the recess in the front-rear direction.

25. The heat treatment furnace according to claim 20, wherein
the protruding portion comprises a second facing surface facing the lower plate member, and
an arithmetic average roughness of the second facing surface is equal to or less than 10 micrometers.

26. The heat treatment furnace according to claim 18, wherein the intermediate member is attached to the upper plate member via an adhesive.

27. The heat treatment furnace according to claim 18, wherein a porosity of the intermediate member is equal to or less than 1%.

28. The heat treatment furnace according to claim 27, wherein the porosity of the intermediate member is less than both of a porosity of the upper plate member and a porosity of the lower plate member.

29. The heat treatment furnace according to claim 28 wherein a bending strength of the intermediate member is equal to or more than 150 MPa and equal to or less than 400 MPa.

30. The heat treatment furnace according to claim 18, wherein
the intermediate member comprises a plurality of intermediate members interposed between the lower plate member and the upper plate member in the up-down direction, and
the plurality of intermediate members is aligned along a front-rear direction.

31. The heat treatment furnace according to claim 18, wherein the intermediate member is constituted of ceramics including a transition metal or a poor metal.

32. The heat treatment furnace according to claim 31, wherein the ceramics comprises non-oxide ceramics including the transition metal.

33. The heat treatment furnace according to claim 32, wherein the non-oxide ceramics is TiB2, TiCN, or MoSi2.

34. The heat treatment furnace according to claim 31, wherein the ceramics comprises oxide ceramics including the transition metal or the poor metal.

35. The heat treatment furnace according to claim 34, wherein the oxide ceramics is Cr2O3, Al₂O3, or Al6O13Si2.

36. A sliding unit for use under a high temperature condition, the sliding unit comprising:
a lower plate member;
an upper plate member disposed above the lower plate member; and
an intermediate member interposed between the lower plate member and the upper plate member in an up-down direction and attached to the lower plate member,
wherein
the upper plate member is configured to move forward above the lower plate member, and
a sliding resistance between the upper plate member and the intermediate member is smaller than a sliding resistance between the upper plate member and the lower plate member.

37. A sliding unit for use under a high temperature condition, the sliding unit comprising:
a lower plate member;
an upper plate member disposed above the lower plate member; and
an intermediate member interposed between the lower plate member and the upper plate member in an up-down direction and attached to the upper plate member,
wherein
the upper plate member is configured to move forward above the lower plate member, and
a sliding resistance between the lower plate member and the intermediate member is smaller than a sliding resistance between the lower plate member and the upper plate member.
